(19) United States
(12) Patent Application Publication
(10) Pub. No.: US 2013/0198026 A1
(43) Pub. Date: Aug. 1, 2013

(54) METHOD AND SYSTEM FOR AN EVENT MARKETPLACE

(71) Applicant: INEVENTION TECHNOLOGY, INC., Saratoga, CA (US)

(72) Inventors: Daniel Marcel PLATZKER, Saratoga, CA (US); Timothy Robert OLSON, San Francisco, CA (US); Michael David OLSON, San Mateo, CA (US)

(73) Assignee: INEVENTION TECHNOLOGY, INC., Saratoga, CA (US)

(21) Appl. No.: 13/755,333

(22) Filed: Jan. 31, 2013

Related U.S. Application Data
(60) Provisional application No. 61/593,735, filed on Feb. 1, 2012.

(51) Int. Cl. G06Q 30/06

(52) U.S. Cl. CPC G06Q 30/0611
USPC 705/26.4

(57) ABSTRACT

A system and method for an event marketplace. The system comprises a first interface for communicating with a plurality of user devices; a second interface for communicating with a plurality of systems of service providers; a progressive accuracy module for at least iteratively computing a set of total cost estimations of the event based in part on an event specification and information retrieved from one or more of the plurality of systems of service providers; and a cost optimizer for providing at least an optimal set of service providers matching the event specification, wherein the optimal set of service providers is ranked by their total cost estimations, the total cost estimation is a function of at least a proposal for a respective service.

### CROSS-REFERENCE TO RELATED APPLICATIONS

This application claims the benefit of U.S. provisional application No. 61/593,735 filed on Feb. 1, 2012, the contents of which are herein incorporated by reference.

### TECHNICAL FIELD

This invention generally relates to techniques for planning and optimizing the cost of professional and social events as well as for event providers to discover and bid for qualified events.

### BACKGROUND

Off-site professional and social events can be very expensive due to travel, accommodations, venues, and other related costs. Event organizers aim to reduce the total cost of an event by coordinating with service providers, such as hotels, conference centers, airlines, and car rental companies that are desirous of reducing their total number of vacancies.

Planning events is not an easy task even if the cost constraint is eliminated. An event planner should consider many parameters in order to plan a successful event. For example, an event planner should consider a set of preferred dates, locations, travel, types of venues, the type of the event, schedule constraints of key guests (e.g., speakers), and so on and so forth.

Thus, there are an enormous number of possible combinations for planning an event. Factoring in a budget for the event complicates the planning problem even more. In fact, currently there is no practical solution for event planners to effectively identify optimized yet suitable locations, venues, dates and other required services, such that the total event cost is minimized. Furthermore, event planners have no practical solution for searching for hotels and other service providers that have high level of vacancy, and therefore would be motivated to negotiate their prices.

Furthermore, the way that the event planning industry currently operates creates certain deficiencies for service providers. Specifically, service providers have little knowledge about planned events that match their services or the characteristics of events being planned, and as such providers cannot proactively offer services to planners based on a potential event's unique features. In addition, service providers do not have an efficient way to determine what price will be lower than their competitors. For example, a sales manager of a particular hotel does not have an efficient way to discover events that could take place in its vicinity, thus the sales manager cannot contact the event planner with an attractive offer with the aim of reducing the hotel vacancy. In addition, multi-location service providers, such as hotel chains, do not have a practical way to help their customers choose between the various locations of their properties, in order to reduce the event cost and total travel expenses for guests attending the event.

It would therefore be advantageous to provide an efficient solution for event planning and discovery that would eliminate the deficiencies noted above.

### SUMMARY

Certain embodiments disclosed herein include an event planning system. The system comprises a first interface for communicating with a plurality of user devices; a second interface for communicating with a plurality of systems of service providers; a progressive accuracy module for at least iteratively computing a set of total cost estimations of the event based in part on an event specification and information retrieved from one or more of the plurality of systems of service providers; and a cost optimizer for providing at least an optimal set of service providers matching the event specification, wherein the optimal set of service providers is ranked by their total cost estimations, the total cost estimation is a function of at least a proposal for a respective service.

Certain embodiments disclosed herein also include a method for planning and optimizing costs of an event. The system comprises a receiving an event specification from a first user; iteratively computing a set of total cost estimations of the event based in part on the received event specification and information retrieved from one or more of the plurality of systems of service providers; and generating at least an optimal set of service providers matching the event specification, wherein the optimal set of service providers is ranked by their total cost estimations, the total cost estimation is a function of at least a proposal for a respective service.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 depicts a diagram of a network system utilized to describe the various embodiments of the invention.

FIG. 2 is a block diagram of an event planning system implemented according to one embodiment of the invention.

FIG. 3 is a flow diagram illustrating the operation of the progressive accuracy module according to one embodiment.

FIGS. 4 and 5 are flow diagrams illustrating the operation a cost estimation procedure according to various embodiments of the invention.

FIG. 6 is an exemplary and non-limiting flow diagram illustrating a process for generating bid requests from service providers according to one embodiment.

### DETAILED DESCRIPTION

The embodiments disclosed herein are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

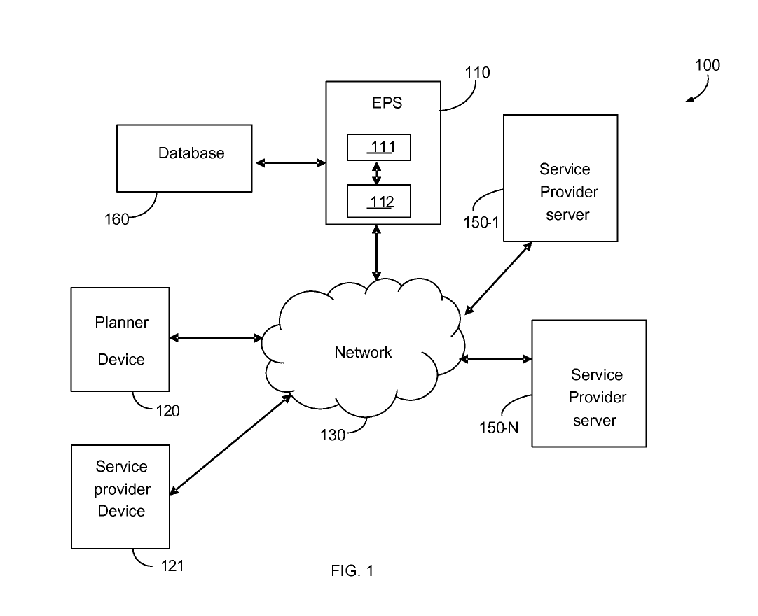

FIG. 1 depicts an exemplary and non-limiting schematic diagram of a network system 100 utilized to describe the various embodiments of the invention. A user can access the disclosed event planning system (EPS) 110 using user devices 120 and 121. Without limiting the scope of the disclosed embodiments, a user of the EPS 110 may be an event planner (or organizer) or a service provider that utilizes devices 120 and 121 respectively.

An event planner may be any person who wishes to plan a social or professional event. For example, an event planner may be parents planning their daughter's sweet-16 birthday or a professional event organizer who needs to plan an international business summit. A service provider user accessing the EPS 110 through the device 121 would typically be a marketer or a sales manager of the service provider. Such a user may update the EPS 110 with special offers respective of a specific service (e.g., a 10% discount for venues booked for certain dates) and also be able to retrieve information about events being planned using the EPS 110. In one embodiment, the EPS 110 may also send information to the device 121, for example, inviting the user of device 121 to provide competitive offers for one or more potential services and suggest price that can increase the winning potential. Each of devices 120 and 121, may be, but is not limited to, a personal computer (PC), a laptop computer, a mobile device, a tablet computer, etc., and is connected to a network 130. Each of the devices 120 and 121 may be able to access the EPS 110 through an API, a web interface, an application installed in the device, so on.

The network 130 can be wired or wireless, a local area network (LAN), a wide area network (WAN), a metro area network (MAN), the Internet, the worldwide web (WWW), the like, and any combinations thereof. From the devices 120 and 121, the users can communicate with the EPS 110 for the purpose of planning events, making an offer for a service, receiving competitive information, and receiving information about future events, as further explained herein below.

Further connected to the network 130 are a plurality of servers 150-1 through 150-N (collectively referred to as servers 150). The servers 150 are systems of various service providers that can offer services or information for the event planner. For example, the servers 150 may include reservations systems of hotels, car rentals, airlines, and the like. The servers 150 may also be systems for providing information, such as tourism information, local attractions, weather information, currency information, and the like.

According to embodiment, the EPS 110 queries the one or more servers 150 for the purpose of planning an event based on inputs provided by the user's device 120. For example, the EPS 110 can query the one or more servers 150 for vacancies and suggested prices. Based on the queries' results, the EPS 110 can plan an event optimized at least by price. The EPS 110 may also provide recommendations for alternative event specifications other than those defined by the event planner. For example, if the planner requests to plan an event in San Diego, the EPS 110 may alternatively recommend holding the event in Las Vegas, for example, based hotels' prices, travel cost, travel time, and other incentives.

According to another embodiment, the EPS 110 can generate and send reservation requests for services to the servers 150 on behalf of an event planner. In yet another embodiment, the EPS 110 can execute a bidding process among a set of service providers selected by the planner or recommended by the EPS 110. Alternatively or collectively, the EPS 110 may generate and send invitations to various service providers to place bids on certain services. The bid invitations may be anonymous, i.e., without disclosing the identity of the event planner. For example, if a planner selects five potential venues for holding the event, the EPS 110 places bids for the price and/or date for reserving the venue. In yet another embodiment, the EPS 110 can book the various services on behalf of the event planner, once the planner has approved the parameters of the planned event. The booking may include, for example, booking of one or more hotel rooms, a venue, air tickets, attraction tickets, and the like. The various embodiments will be described in detail herein below.

The EPS 110 includes a processing unit, such as processor 111 that is coupled to a memory 112. The memory 112 contains instructions that when executed by the processor 111 results in the performance of the methods discussed herein. The EPS 110 may also be connected to a database 160. The database 160 stores at least past and future events, event recommendations, and the like created by the EPS 110. In one embodiment, service providers can access the contents of the database 160 through the EPS 110 in order to place offers on specific services or for events that have not yet been booked. The EPS 110 presents to providers only events that are uniquely relevant to each provider. For example, a sales manager of a hotel in San Diego cannot view events that are planned to be held in New York. It should be noted that the database 160 may be integrated in the EPS 110.

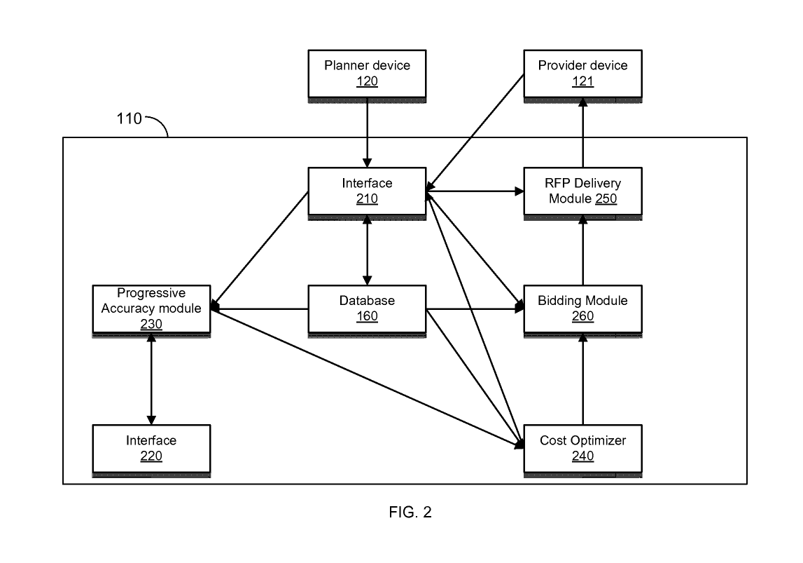

FIG. 2 shows an exemplary and non-limiting block diagram of the EPS 110 according to one embodiment of the invention. The EPS 110 comprises a user interface 210 providing an interface to devices 120 and 121, and a service provider interface 220 allowing the EPS to communicate with the servers 150 of the service providers. The EPS 110 also includes a progressive accuracy module 230, a cost optimizer 240, a request for proposal (RFP) module 250, a bidding module 260, and the database 160.

Each of the interfaces 210 and 220 may be realized through a web interface, a GUI, an API, or combination thereof. Event planners, by means of device 120, can access the EPS 110 through the interface 210 to enter the events' requirements and constraints. For example, a planner can define acceptable dates for events, the number of attendees and how many attendees plan to arrive from what location, the number and size of meeting rooms, meals, hotel star levels, hotel geographical location (such as in the west coast near a beach, in Western Europe, everywhere other than a specified country, etc.), nearby attractions, weather, at a resort, on a cruise ship, in or near a large city or airport, audiovisual equipment requirements, transportation and flight requirements (e.g., flights cannot be with more than 1 stop), maximum budget, and so on. In addition, the planners can also set their expected commission from the various service providers. In one embodiment, the information entered by the planner is saved in the database 160.

Through the interface 210 the device 120 of the planner can receive alerts and information generated by the EPS 110. For example, alerts in response to a bid by a service provider, event service providers ranked by cost, and so on. As noted previously, personnel of service providers can also interface with the EPS 110. This is performed through the interface 210.

The cost optimizer 240 analyzes, for each event, the total cost value calculated for each service provider, computed by the module 230, which generates at least the following: a total cost estimate for each event in the database 160, and a list of service providers that match the event's requirements, ranked by estimated total cost. The cost optimizer 240 also generates a list of events ranked by a service provider's cost relative to other service provider's bidding or estimated event costs.

The outputs generated by the optimizer 240 may be in a form of reports communicated to the planner's device 120. Such reports can be sent to the device 121 of the service providers' personnel.

Responsive to the information generated by the cost optimizer 240, the event planner by means of device 120 can initiate the RFP module 250 to send requests for proposals (RFPs) to one or more service providers. With this aim, the RFP module 250 retrieves selected event's details for each event selected by the planner from the database 160 and generates RPFs to service providers (e.g., hotels) designated in the event details. For example, RFPs can be sent by means of emails, a web interface, or an application interface (API) provided the service providers. In another embodiment, the RFP module 250 can be initiated by the bidding module 260.

The progressive accuracy module 230 uses the events' constraints and requirements entered by the planner to determine which of the service providers' servers 150 should be queried and which information should be requested from the servers 150 that are queried. This determination is based in part on the data that would be useful for the cost optimizer 240, as well as efficient for collection by the EPS 110. The module 230 allows selective and efficient use of queries sent to servers 250 through the interface 220, thus reducing the overall planning time of an event.

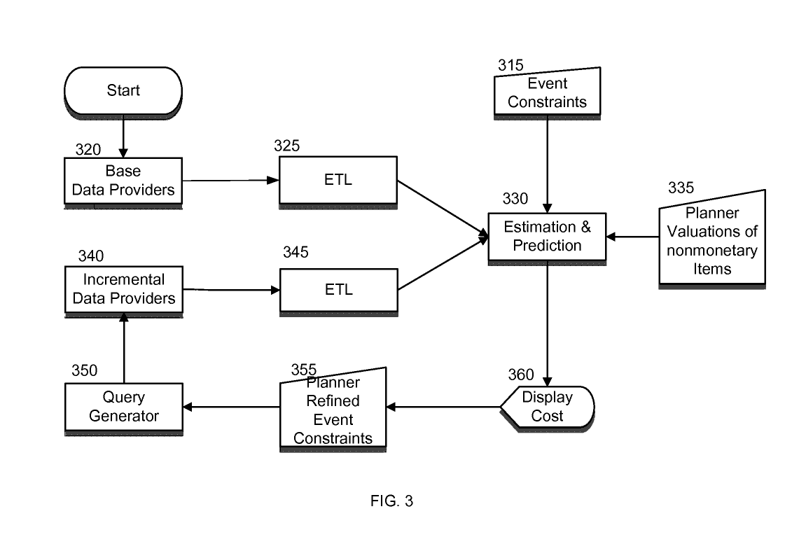

FIG. 3 is an exemplary and non-limiting flow diagram illustrating the operation of the progressive accuracy module 230 according to one embodiment. The process performed by the module 230 may be triggered in response to an event's specifications entered by the event planner, in response to an RFP, or in response to an unsolicited bid from a service provider. The module 230 generates and sends real time queries to service providers in order to receive updated information respective of the planned event.

In 320, a set of baseline data from the data providers is acquired. The baseline data may include, for example: information about all available venues (e.g., hotels, convention centers, manors, etc.). For such venues the module 330 retrieves an address, a size of meeting space, a number of sleeping rooms, amenities, pricing information, and so on.

The baseline data may also include information about travel options, including but not limited to: flight route availability, pricing, and flight duration, car rental rates, taxicab rates, train fares, and so on, information about destinations and local attractions, weather Information, and so on. One of ordinary skill should appreciate that any information that may be useful for planning an event can be acquired from the service providers through the servers 150.

In 325, the acquired baseline data is transformed into a standard format compatible with a format that can be processed by the progressive accuracy module 230 and the database 160. According to one embodiment, in 320, an extract, transform and load (ETL) process is performed. Thereafter, the acquired data in the modified format is saved into the database 160.

In 330, the estimation and prediction procedure takes place. The process 330 estimates the costs for the event based on the baseline data, input event constraints (315) and the event planner's valuations of un-priceable (or non-monetary) items (335). The event constraints may include a wide range of restrictions, for example, the weather at the destination must be warm, a meeting room must have a certain ceiling height, a golf course must be located nearby, the travel time from the airport must be less than a certain maximum, and so on.

The planner valuations of un-priceable items may also be input by the planner through device 120. Such items may include information including but not limited to the relative importance of lowering the group's total travel time versus saving money on travel cost, the opportunity cost of contract cancellation clauses, the value of having a meeting on the beach instead of one block away from the beach, and so on.

The cost estimates generated in 230 are displayed to the event planner (360), thereby allowing the planner to redefine the event constraints and/or requirements (355). The redefinition of the event constraints/requirements may be based upon specific selections of data providers, dates, approval of RFPs, and the like.

In 350, an updated query is generated and sent to the servers 150 to retrieve incremental data from service providers respective of the modified event constraints and/or requirements. It should be noted that the modified queries may be sent to the same or different service providers from those initially queried.

As shown in FIG. 3, the incremental data retrieved from the servers 150 in 340, is transformed into a format compatible with the ESP 110 (345) and input to the cost estimation procedure in 330. In response, the revised estimation costs for the event are generated and displayed to the user. The process illustrated in FIG. 3 continues as long as new events' constraints are provided by the event planner.

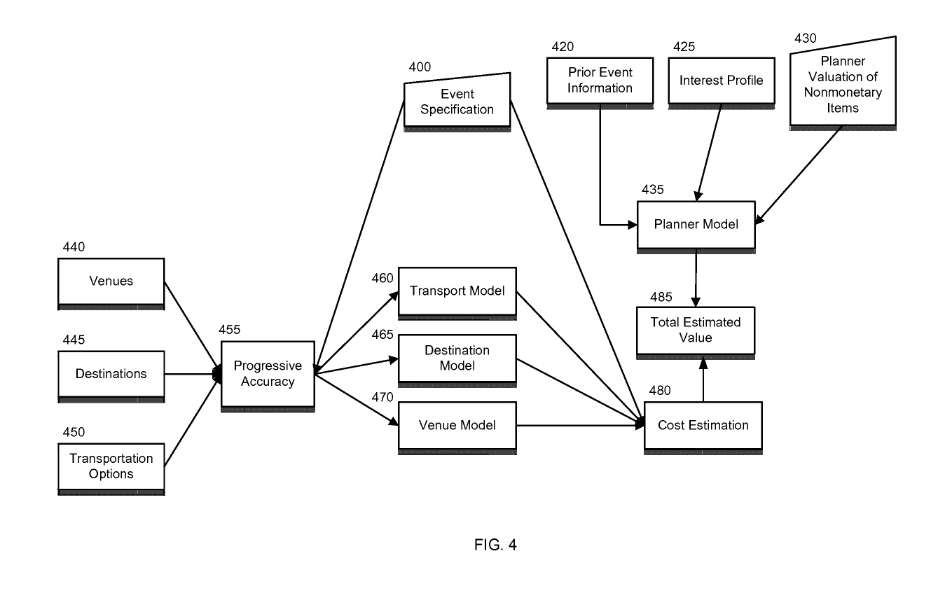

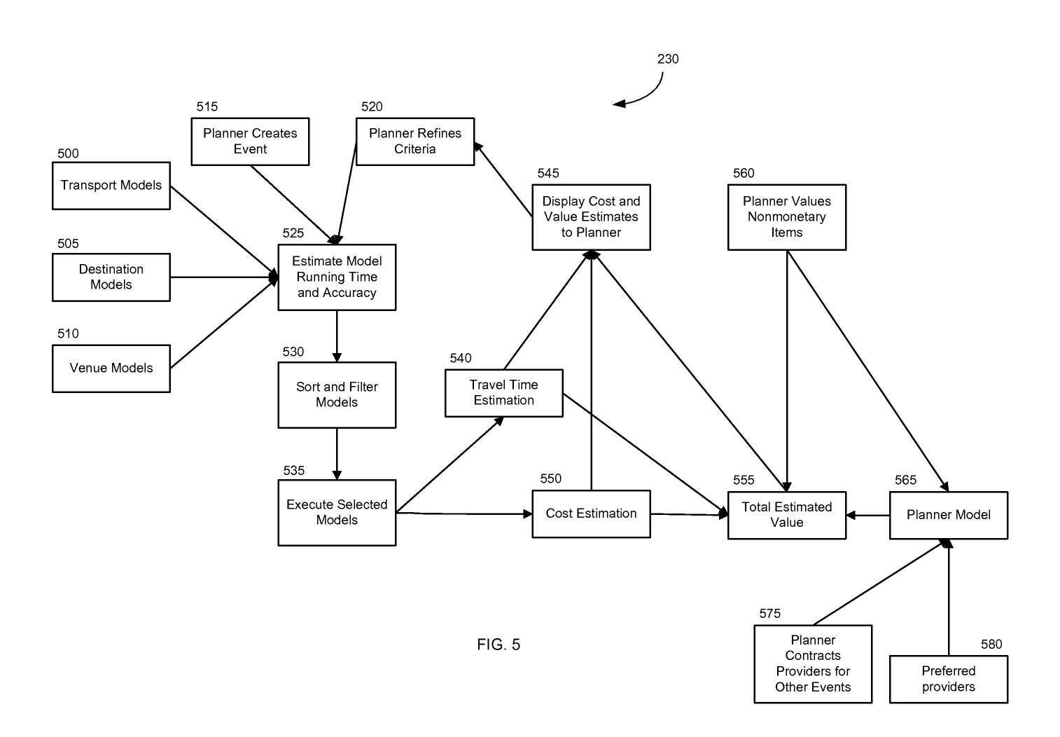

The operation of the cost estimation procedure (330) is further described with reference to FIGS. 4 and 5. This procedure uses all available information to produce an estimate for the total cost of having an event with each service provider. Because the event is better defined by the event planner, through the redefined constraints, the additional information is used to provide more accurate estimates.

Referring now to FIG. 4, in 400, the event planner provides an event specification including the event attendees, their origin locations, the acceptable destinations for having the event, venue types, budgetary constraints, and so on. In 455, the event specification is used to select at least relevant venues (440) and transportation opinions (450) from respective service providers. In one embodiment, 455 is performed by means of a progressive accuracy process. For example, if the number of acceptable combinations of venues and transportation options is large, not all combinations can be queried because of the combinatorial explosion.

In 455, the progressive accuracy process handles this problem by using the constraints from the event specification to select an optimal set of combinations. The progressive accuracy process also activates at least a transport model 460 and a venue model 470 to produce additional information that is necessary for the selected combination. In one embodiment, these models provide cost estimations, if such information is missing. The cost estimations generated by the models 460 and 470 may include, for example: flight costs, cab fares, cost for hotel rooms, food and beverage costs, taxes, predicted results of negotiations, and so on. In one embodiment the progressive accuracy process can utilize the destination model 265 to select the optimal combination of venue and transportation options.

In 480, once all of the cost estimations have either been directly collected by progressive accuracy process (in 455) or estimated by one of the models, a total aggregated cost estimation is compiled for each service provider qualified by the constraints designated in the event specification. In one embodiment, the cost estimations are ranked by the providers. It should be noted that the cost estimations generated in 480 become more accurate as the event becomes fully planned and as proposals are received from the respective service providers.

Even with fairly complete and accurate cost estimations computed for each provider in 480, the final selection process often involves significant intangible and nonmonetary considerations. For example, one hotel may be on the beach, whereas another hotel is across the street, and how much is the difference worth to this particular event. To address such intangibles, the event planner may provide an input in a form of nonmonetary items (430). Such items offer valuations of various nonmonetary considerations and are provided to a planner model together with prior event information 420 and an interest profile 425.

In 435 the planner model approximates how a planner ultimately values a proposal. In 485 a total estimated value for each provider is generated using the output of the planner model and the cost estimations. The total estimated value represents the total net value of having an event with a given provider. This value may also be presented to the event planner throughout the process, and may be updated as the planner interacts with the EPS 110, gives more information about the event, and as proposals from all the providers are received.

FIG. 5 shows an exemplary and non-limiting diagram illustrating the operation of the cost estimation procedure (330) according to another embodiment. In 515, the event planner enters an event specification for a planned event. The event specification includes at least at a minimum, acceptable dates for the event, guidelines for acceptable locations, and basic information about the attendees, such as the number of attendees and their origin locations. A large amount of optional information may be included to further specify the event, such as specifications for meeting room configurations, audiovisual equipment, proximity to attractions, etc. It should be noted that all inputs with respect to the event may be added incrementally when a detailed planning is needed or such inputs can be updated during the event planning.

In 525, the event constraints defined in the input event specification are used to evaluate the available estimation models for computational running time and accuracy. For example, if there are a large number of dates and/or locations allowed by the event specification, the transport models which estimate the cost and travel time of arriving from an origin to a destination will have a large number of combinations to evaluate, thus the estimation process may be very slow. Transport models which use statistical estimation for travel cost and time may be faster but less accurate than models which look up actual price data from the current market.

With this aim, the estimate model in 525 uses the event constraints defined in the event specification for each transport model (500) and venue model (510), and optionally the destination model (505) to generate running time and accuracy metrics for each model, given the constraints of the current event. These model metrics are then, in 530, ordered and prioritized to run based on business oriented heuristics. For example, a fast but inaccurate model may be sorted to the top of the model list enabling the event planner to receive an immediate feedback about the estimated cost and value of various providers. In contrast, a slow but more accurate model may be sorted towards the bottom of the model list to provide the event planner with the best cost and value estimates, but only after the extended duration needed to complete the model.

In 535, the models according to their order in the list are executed. The execution of a model provides the estimated cost for the respective part of the event (e.g., travel, food and beverage, lodging, etc.). In one embodiment, the extraction of the transportation model generates travel time and cost estimations.

In 550, cost estimations of all executed models are aggregated to provide an estimate of the cost of having an event with a particular provider. The total cost output of 550 is displayed to the event planner in 545. Optionally, the total estimated travel time, as computed in 540, is also displayed.

After reviewing costs, travel times, and total estimated values, the planner may decide to adjust their event specifications, modifying or adding constraints by supplying user generated input in 520. This additional user generated input from 520 is combined with the original input (provided in 515) and fed to the estimate model (525) in order to repeat the cycle of model selection and time and cost estimation, and then display the refined estimates.

Since providers are non-fungible, total cost is not the only consideration for an event planner. Intangibles such as the quality of service, the travel time to get to the provider, nearby attractions to the provider, and so on, may all affect the total perceived value to the planner of having an event with a given provider. This total perceived value may be estimated by adjusting the cost estimations by the planner's valuation of these intangible items.

In 560, the event planner can assign valuations to nonmonetary items, such as the value of a location or the opportunity cost of travel time. In 555 the total estimated cost value is generated based on the nonmonetary items.

In one embodiment, if the valuation of nonmonetary items has not been provided, or if they are insufficient, the total estimated value can be computed using a planner model executed in 565. The planner model is a statistical or machine learning-based model which represents the preferences of the planner, and provides valuation outputs to relate to nonmonetary items.

The input to planner model is a variety of behavioral information gathered about the event planner from previous activities. Such activities may include, but are not limited to, contracts that the providers sign for other events (575), a history of prior events managed by this planner, the valuations for the prior events that the provider selected for that event, and so on. The input to the planner model may also include preferred service providers for the event planner. The total estimated value per each service provider that may be utilized in the event as defined by the input event specification is displayed to the planner in 555.

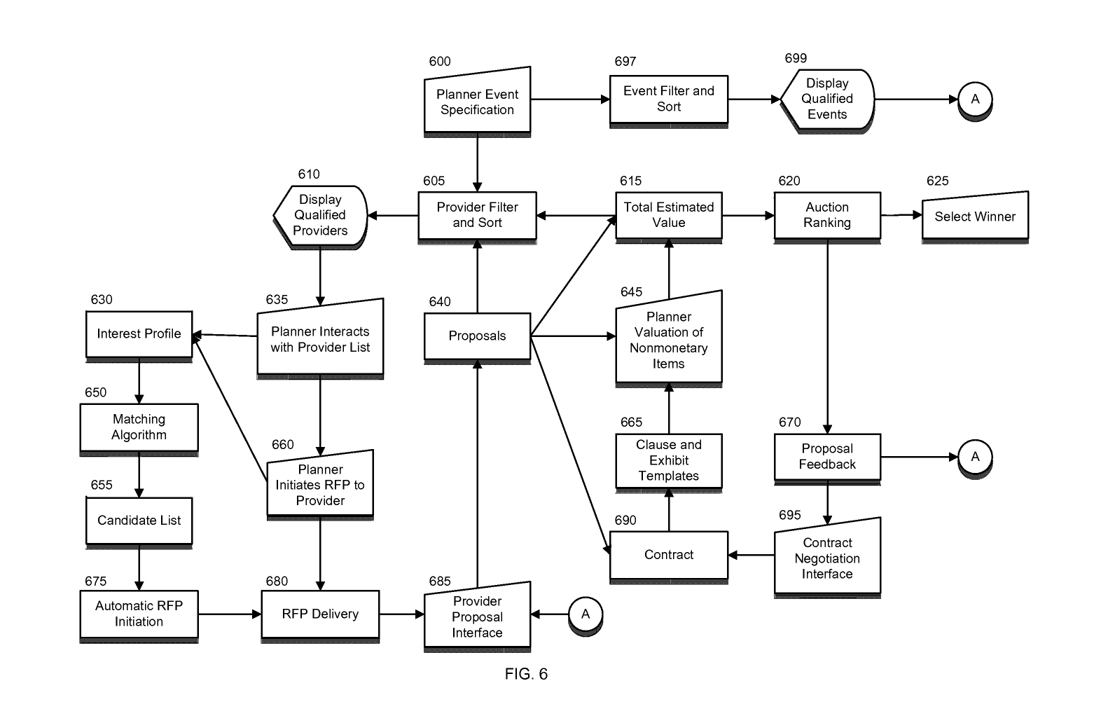

FIG. 6 is an exemplary and non-limiting flow diagram illustrating a process for generating bid requests to service providers according to one embodiment. The process may be performed by the bidding module 260. The process generates invitations for service providers to bid on the planners' events.

In 600, the event specification is received. In 605, a qualification process may filter the service providers based upon a wide variety of criteria, including, for example: the star rating of a hotel, peers' opinions, estimated travel cost to a destination, availability of particular amenities, proximity to nearby attractions, and so on. The filtered list of service providers is displayed to the planner in 610.

In 635, one or more qualified service providers is selected by the planner. In 660, the planner selects those providers to which an RFP should be sent. For each such provider, in 680, an RFP is generated through the RFP delivery module 250. Furthermore, in 630, information about the providers of interest is collected and compiled into an interest profile. This information may include, for example: which providers the planner views, to which providers planner sent RFPs, how much time the planner spends researching each provider, the order of sorting used by the planner to display the providers, any additional filters the planner applies to the list of providers, responses to generated suggestions that list certain providers or destinations, solicitations to a planner's response (such list can be dynamically build based on providers promotions or static characteristics), and so on.

In one embodiment, the list of service providers in the interest profile can be shared with the providers. This would enable a service provider to offer certain promotions to the event planners. The interest profile 630 may also be utilized to invite additional providers that have not been selected by the planner, to bid. In such a case, some event information, for example the planner identity, may be hidden. With this aim, in 650, a matching algorithm is applied to the providers listed in profile. The matching algorithm includes statistics, machine learning algorithms, heuristics, and other methods to generate a candidate list of providers sorted by likelihood of being of interest to the planner.

In 675, for providers in the candidate list, RFP's are initiated. Then, in 680, an RFP is generated through the RFP delivery module 250. In 685, each provider that receives an RFP is allowed to provide a bid on the respective service. The invitation to bid to each provider may be sent through an e-mail, a web interface, or an API.

In one embodiment, service providers that have not received an invitation to bid can still initiate a proposal through the following process: all of the input events generated are processed by an event filter in 697. The event filter ranks the events based on suitability for a particular provider. The event filter may use information such as, but not limited to, dates for which that provider has vacancies, number of event attendees, required hotel rooms and meeting rooms, event budgets, and so on, whether the provider has the amenities required by the event specification, whether the provider's destination has suitable weather as required by the event specification, the estimated cost for the planner's group to travel to the provider, the event budget, the cost of a certain provider relative to other providers and so on. The filtered list of events is presented to the provider in 699 along with bid invitations for all events for which the provider is qualified. The provider may then use interface 685 to generate a proposal, even in the absence of an explicit RFP being sent to the provider. In such case some information may be hiding such as the planner identity.

In response to the bid invitations, in 640, a set of proposals is generated by the service providers. The proposals may include pricing for sleeping rooms, meeting rooms, and audiovisual equipment; fees for housekeeping, porters, valet, taxes; terms and conditions including cancellation clauses, minimum expenditures, payment terms, and service guarantees; food and beverage menus and pricing, and so on. The set of proposals is then filtered and sorted in 605, to adjust and augment the information for display in 610.

The proposal information may also include partial or a complete text of a service contract with the respective service provider. The contracts (690) may be expressed as freeform text, structured clauses, or both. Any structured information in the contracts, may be extracted, in 695, into clauses and templates, which is a set of industry-standard contract clauses along with associated parameters.

Because the clauses and templates are structured and industry-standard, they may be subject to comparison across contracts and proposals, and may have relative valuations of nonmonetary items added by the planner, in 645. The nonmonetary items allow for specifying an exact or relative value to items which are normally not priced, such as, but not limited to, contract terms, proximity to attractions, the value of destinations with better weather, peers' opinions, the opportunity costs associated with travel time to the provider's location, and so on. In 615, using the pricing information from the set of proposals and the nonmonetary items, a total estimated value is calculated. As discussed above, the total estimated value represents the overall desirability of having the event with a specific provider. In 605 total estimated values for all providers are filtered and sorted to allow the planner to further refine their search.

According to certain embodiments, in 620 an auction ranking takes place. Accordingly, the providers are ranked by their total estimated values for a particular event. In 625, the planner may a select a provider based on the ranked list, thereby ending the auction process. Alternatively, while the auction is still performed, in 670, the ranked list of providers may be used to generate a proposal feedback, allowing the provider to understand their overall standing in the bidding process, as well as the impact any changes in their proposal may have on their location in the list, thereby allowing the providers to improve their proposals.

The foregoing detailed description has set forth a few of the many forms that different embodiments of the invention can take. It is intended that the foregoing detailed description be understood as an illustration of selected forms that the invention can take and not as a limitation as to the definition of the invention.

Most preferably, the various embodiments discussed herein can be implemented as hardware, firmware, software, or any combination thereof. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

What is claimed is:

1. An event planning system, comprising:
a first interface for communicating with a plurality of user devices;
a second interface for communicating with a plurality of systems of service providers;
a progressive accuracy module for at least iteratively computing a set of total cost estimations of the event based in part on an event specification and information retrieved from one or more of the plurality of systems of service providers; and
a cost optimizer for providing at least an optimal set of service providers matching the event specification, wherein the optimal set of service providers is ranked by their total cost estimations, the total cost estimation is a function of at least a proposal for a respective service.

2. The system of claim 1, further comprising:
a bidding module configured to initiate a bidding process among the service providers matching the event specification, wherein the bidding module is further configured to anonymously invite service providers in the optimal set of service providers.

3. The system of claim 2, further comprising:
a request for proposals (RFP) module for generating and sending a request for proposals for a respective service from each of the service providers matching the event specification.

4. The system of claim 3, further comprising:
a database configured to store at least: past events, future events, event recommendations, event specifications, and information retrieved from the one or more of the plurality of systems of service providers.

5. The system of claim 1, wherein the plurality of user devices includes at least a user device of an event planner and a user device of the service providers' personnel.

6. The system of claim 5, wherein the event planner provides at least the event specification and updated specification during a planning process of the event, wherein the event specification defines a plurality of event requirements and at least one event constraint for the event.

7. The system of claim 6, wherein the event requirements include at least a list of acceptable destinations, venue types, origin locations of event attendees, and dates, wherein the at least one event constraint is at least a budgetary constraint.

8. The system of claim 5, wherein the service providers' personnel can interface with the system to at least retrieve information about planned events and update proposals for respective services.

9. The system of claim 7, wherein the progressive accuracy module is further configured to:
select the one or more service providers from which to retrieve information;
determine a type of information to retrieve from the selected one or more service providers, wherein the determination is based in part on the requirements and constraints as defined in the event specification;
determine the optimal set of service providers that can provide services to the event;
initiate at least one of the RFP modules and bidding modules to send request for proposals for services provided by the service providers that are included in the optimal set of service providers;
predict proposals for services for which information cannot be retrieved from service providers; and
compute a total cost estimation for each of the service providers in the optimal set of service providers based in part on at least one of a received proposal, a predicated proposal, and at least one non-momentary item, wherein a proposal includes a cost for the requested service and contract terms.

10. The system of claim 9, wherein the progressive accuracy module is further configured to determine the optimal set of service providers and to predeict proposals for services based in part on a transportation model and a venue model.

11. The system of claim 9, wherein the total cost estimation is computed as a function of at least an accommodation cost, a travel cost, and the at least one non-momentary item.

12. The system of claim 1, wherein the event is any one of a social event and a professional event.

13. A method for planning and optimizing costs of an event, comprising:
receiving an event specification from a first user;
iteratively computing a set of total cost estimations of the event based in part on the received event specification and information retrieved from one or more of the plurality of systems of service providers; and
generating at least an optimal set of service providers matching the event specification, wherein the optimal set of service providers is ranked by their total cost estimations, the total cost estimation is a function of at least a proposal for a respective service.

14. The method of claim 13, further comprising:
initiating a bidding process among the service providers matching the event specification, wherein the bidding process sends anonymous invitations to place a bid on a respective service to the service providers matching the event specification.

15. The method of claim 14, further comprising:
generating and sending a request for proposals for a respective service from each of the service providers in the optimal set of service providers.

16. The method of claim 13, further comprising:
enabling the service providers' personnel to interface with the system to at least retrieve information about planned events and update proposals for respective services.

17. The method of claim 13, wherein the event specification defines a plurality of event requirements and at least one event constraint for the event, wherein the event requirements include at least a list of: acceptable destinations, venue types, origin locations of event attendees, and dates, wherein the at least one event constraint is at least a budgetary constraint.

18. The method of claim 17, wherein computing the set of total cost estimations further comprising:
selecting the one or more service providers from which to retrieve information;
determining a type of information to retrieve from the selected one or more service providers, wherein the determination is based in part on the requirements and constraints as defined in the event specification;
determining the optimal set of service providers that can provide services to the event;
sending at least one of a request for proposals and a bid invitation module for proposals for services provided by the service providers in the optimal set of service providers;
predict proposals for services for which information cannot be retrieved from service providers; and
computing a total cost estimation for each of the service providers in the optimal set of service providers based in part on at least one of a received proposal, a predicate proposal, and at least one non-momentary item, wherein a proposal includes a cost for the requested service and contract terms.

19. The method of claim 18, wherein the total cost estimation is computed as a function of at least an accommodation cost, a travel cost, and the at least one non-momentary item.

20. A non-transitory computer readable medium having stored thereon instructions for causing one or more processing units to execute the method according to claim 13.
